(19) United States
(12) Patent Application Publication
(10) Pub. No.: US 2011/0001299 A1
(43) Pub. Date: Jan. 6, 2011

(54) VEHICLE HAVING AN AXLE CAPABLE OF PENDULUM MOTION

(76) Inventors: Sebastian Wagemann, Oelde-Suennighausenl (DE); Manfred Gersmann, Warendorf (DE)

Correspondence Address: MICHAEL J. STRIKER, 103 EAST NECK ROAD, HUNTINGTON, NY, 11743, US

(21) Appl. No.: 12/824,527

(22) Filed: Jun. 28, 2010

(30) Foreign Application Priority Data
Jul. 1, 2009 (DE) 10 2009 031 426.1

(51) Int. Cl. B60G 9/02

(52) U.S. Cl. 280/124.112; 280/124.111

(57) ABSTRACT

A vehicle, has a chassis, at least one front axle assigned to the chassis and carrying land wheels, a rear axle located downstream of the front axle, relative to a direction of forward travel and carrying at least two steerable wheels, wherein the rear axle is hingedly connected to the chassis such that it is movable to and fro transversely to the direction of travel, and includes at least one axle body, wherein regions of the chassis are assigned to the wheels of the rear axle in an at partially adjacent manner, a pendulum device coupling the rear axle of the chassis and enabling a displacement of the rear axle that is oriented transversely to the direction of travel, and a swivel device coupling each wheel of the rear axle to the axle body of the rear axle and enabling a displacement of each wheel that is oriented transversely to the direction of travel.

### CROSS-REFERENCE TO RELATED APPLICATION

The invention described and claimed hereinbelow is also described in German Patent Application DE 10 2009 031 426.1 filed on Jul. 1, 2009. This German Patent Application, whose subject matter is incorporated here by reference, provides the basis for a claim of priority of invention under 35 U.S.C. 119(a)-(d).

### BACKGROUND OF THE INVENTION

The invention relates to a vehicle having an axle capable of performing reciprocating motion.

DE 10 2007 025 598 A1 made known an agricultural working machine designed as a combine harvester, the rear axle of which is disposed on the chassis of the combine harvester in a manner that allows it to perform reciprocating motion. In one variant embodiment, the rear axle, which includes steerable wheels, is disposed on the chassis using two pivotable control arms. The geometry of the control arms is designed such that the rear axle can perform a pendulum motion about a virtual pendulum axis if necessary due to uneven terrain, wherein the pendulum motion simultaneously induces a displacement of the rear axle transversely to the direction of travel of the agricultural working machine. This motion has the effect of preventing the steered wheels from colliding with the regions of the chassis adjacent to the wheels, and therefore uneven terrain does not result in a reduction of the possible steering angle.

Since the transverse displacement, which occurs due to the pendulum motion, takes place only on uneven terrain, the possible steering angle in the plane is dependent on the available free spaces of the steered wheels relative to the cladding pieces of the chassis. This available free space decreases considerably as the size of the machine increases since the more complex-designed working mechanisms of the agricultural working machine require more installation space, and since larger wheels are required due to the greater machine masses. As a result, the maximum steering angle that can be implemented in the plane decreases.

EP 1 154 925 makes known a further pendulum-axle structure, in which the rear axle is hingedly mounted via a pivot axle to the chassis of the agricultural working machine, thereby enabling the wheels of the rear axle to follow uneven terrain. This widely used structure of pendulum axles has the disadvantage, however, that, when uneven terrain is covered, the rear axle moves about the pendulum axle on a circular trajectory, and therefore the upper regions of the land wheels that are located on the uphill side are each moved in the direction of the cladding pieces of the chassis. To prevent these collisions, FP 1 154 925 provides an axle structure, in which the king pin is positioned ahead of the stub axle hub relative to the direction of forward travel, and, simultaneously, the steered land wheels are fixed in the axle body in a telescoping manner. Although the position of the king pin makes it possible to implement greater steering angles within narrow limits, the actual effect is attained by the fact that the land wheels can be pulled laterally out of the rear axle during working operation, thereby enabling the wheels to move further away from the cladding pieces of the chassis.

A retrofitting process of this type is complex since the machine must be lifted for this purpose, at least in the region of the rear axle. In addition, before a field is entered, it is difficult to determine what type of uneven terrain may be involved, and therefore the extended position of the steered wheels need not correspond to the actual uneven terrain that will be crossed. As a result, the steered wheels can collide with the cladding pieces of the chassis when uneven terrain is crossed, even though the position of the spindle was changed.

### SUMMARY OF THE INVENTION

The object of the present invention, therefore, is to avoid the described disadvantages of the prior art and, in particular, to provide an axle structure that large steering angles can be implemented without the steered wheels colliding with the chassis of the vehicle.

In keeping with these objects and with others which will become apparent hereinafter, one feature of the present invention resides, briefly stated in a vehicle, comprising a chassis, at least one front axle assigned to said chassis and carrying land wheels, a rear axle located downstream of said front axle, relative to a direction of forward travel and carrying at least two steerable wheels, wherein said rear axle is hingedly connected to said chassis such that it is movable to and fro transversely to the direction of travel, and includes at least one axle body, wherein regions of said chassis are assigned to said wheels of said rear axle in an at partially adjacent manner, a pendulum device coupling said rear axle of said chassis and enabling a displacement of said rear axle that is oriented transversely to the direction of travel, and a swivel device coupling each wheel of said rear axle to said axle body of said rear axle and enabling a displacement of each wheel that is oriented transversely to the direction of travel.

Given that the vehicle comprises at least one front axle which is assigned to the chassis and carries land wheels, and a rear axle which is located downstream, relative to the direction of forward travel, of the front axle and carries at least two steerable wheels, wherein the rear axle is hingedly connected to the chassis such that it can oscillate transversely to the direction of travel, and given that the vehicle comprises at least one axle body, and that regions of the chassis are assigned are assigned to the wheels of the rear axle in an at least partially adjacent manner, wherein the rear axle is coupled to the chassis using a pendulum device that makes possible a displacement of the rear axle that is oriented transversely to the direction of travel, and each wheel of the rear axle is coupled to the axle body of the rear axle using a swivel device that makes possible a displacement of each wheel that is oriented transversely to the direction of travel, it is ensured that the vehicle can realize large steering angles on even terrain and on uneven terrain without the steered wheels colliding with the chassis.

In an advantageous embodiment of the invention, the pendulum device is designed as a coupler mechanism, wherein the displacement of the rear axle transversely to the direction of travel is caused by the slope-induced movement of the coupling elements of the coupler element. An embodiment of this type has the advantage, in particular, that the position of the rear axle responds immediately to the actual slope, thereby ensuring that the steered wheels are always prevented from colliding with the chassis, regardless of the intensity of the slope.

The steered wheels are likewise reliably prevented from colliding with the chassis in a further advantageous embodiment of the invention in that the displacement of the rear axle results in an increase in the distance between the wheel lying in the direction of the displacement and the region of the chassis adjacent to it, while the further wheel is swiveled underneath the region of the chassis adjacent to this wheel.

In an advantageous development of the invention, the coupling elements are designed as control arms situated in pairs, each of which is connected to the axle body and the chassis by upper and lower joints, wherein the distance between the upper joints of the control arms is smaller than the distance between the lower joints of the same. A structure of this type has the advantage that a structure that is appropriate for the force involved is retained even on uneven terrain, and the structure transfers the support loads of the vehicle to the ground via a short route. These effects are intensified even further when, in a further advantageous embodiment of the invention, the upper and lower joints of each of the control arms, which are situated in pairs, are separated by the same distance, and this distance is smaller than the distance between the lower joints.

In an advantageous development of the invention, the pendulum device is designed as a coupler mechanism, wherein the displacement of the wheels of the rear axle relative to its axle body, which is oriented transversely to the direction of travel, is caused by the activation of the movement of the coupling elements of the coupler element. A structure of this type for adapting the steered wheels to the particular axle body has the main advantage that, depending directly on the steering angle that is chosen, the position of the steered wheels undergo a transverse displacement and the lateral change in position increases as the steering angle increases.

A coupler mechanism structure that has a simple design and is therefore cost-favorable is attained in an advantageous development of the invention when the coupler mechanism of the swivel device includes the following coupling elements, at the least:
a swivel supports that is assigned to each wheel and is fastened to the rear axle,
a king pin that is accommodated by the swivel supports in a pivoting manner
a spindle that leads into a spindle hub and is rotatably connected to the king pin, the spindle hub accommodating the respective wheel, and
the king pin is located ahead of the respective spindle relative to the direction of forward travel.

Given that every coupler mechanism includes a track rod fastening part, which is assigned to each swivel supports, for the pivotable accommodation of a track rod, the necessary return of the steered wheels to the “straight-ahead” track is easily integrated in the swivel device according to the invention.

In a technically proven and structurally simple manner, the steering motion of the steered wheels is realized in that a steering cylinder that is designed as a double-acting lifting cylinder is assigned to the rear axle, is fixed in position on the axle body of the rear axle, and is coupled to each of the track rods in a pivoting manner.

In an advantageous development of the invention, large, collision-free steering angles can be implemented using the vehicle when the wheels of the rear axle assume a position in the maximum curve position in which the inner wheel has a front edge that is located in the vicinity of the region of the chassis adjacent to this wheel, and in which a rear edge of the outer wheel is located in the vicinity of the region of the chassis adjacent to this wheel.

In an advantageous embodiment of the invention, the vehicle attains small turning radius and, therefore, great maneuverability when, in the maximum curve position, the inner wheel has a turning radius that is smaller than the turning radius of the outer wheel.

Due to the very limited installation space present in agricultural machines and continually increasing tire sizes, the effects described herein are best utilized when the vehicle is designed as an agricultural working machine, in particular a combine harvester.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 a side view of an agricultural working machine

FIG. 2 a front view of the rear axle, according to the invention, in viewing direction A indicated in FIG. 1

FIG. 3 a top view of the rear axle according to the invention

### DESCRIPTION OF THE PREFERRED EMBODIMENTS

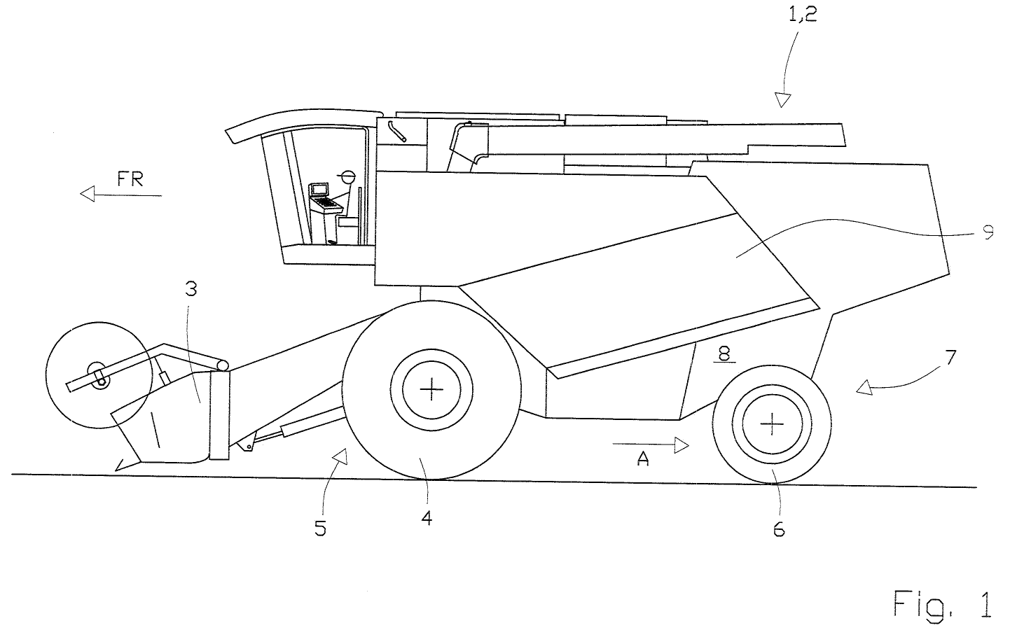

FIG. 1 shows an agricultural working machine 1 which is designed as a combine harvester 2 and includes a front axle 5 which carries land wheels 4, is located on the front side, and is located downstream of an adapted front attachment 3, land wheels 4 are rigidly connected to front axle 5 and are actively driven. In the rear region of agricultural working machine 1, a rear axle 7, according to the present invention, which accommodates steered wheels 6, is located downstream of front axle 5, wherein regions 8 of chassis 9 of agricultural working machine 1 are assigned to steered wheels 6, in an at least partially adjacent manner, and in a manner to be described in greater detail.

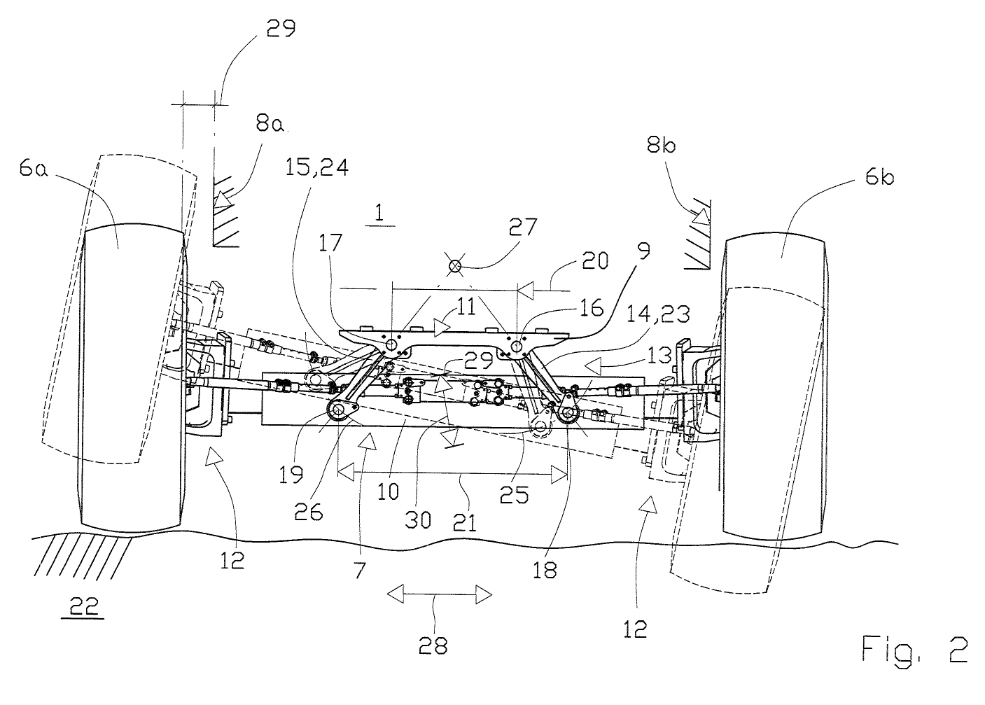

FIG. 2 shows a detailed view of rear axle 7 according to the invention. Rear axle 7 includes an axle body 10 which is hingedly connected in a pivoting manner to chassis 9 of agricultural working machine 1 using a pendulum device 11 to be described in greater detail. In addition, each of the steered wheels 6a, b of rear axle 7 is connected via a swivel device 12, which will be described in greater detail, to axle body 10 of rear axle 7.

Pendulum device 11 is formed by a coupler mechanism 13 which includes control arms 14, 15 that are designed as rocker arms and are situated in pairs, wherein each control arm 14, 15 is pivotably fastened to chassis 9 using a respective upper joint 16, 17. In addition, each control arm 14, 15 accommodates a respective lower joint 18, 19, using which respective control arm 14, 15 is pivotably adapted to axle body 10 of rear axle 7. Upper and lower joints 16-19 are positioned relative to each other such that distance 20 between upper joints 16, 17 is smaller than distance 21 between lower joints 18, 19 of control arms 14, 15 which are situated in pairs.

Depending on the slope of ground 22 transversely to direction of travel FR, control arms 14, 15, which form coupling elements 23, 24 of coupler mechanism 13, swivel about upper joints 16, 17 on circular trajectories 25, 26 shown in FIG. 2. Simultaneously, rear axle 7 moves to and fro about a virtual pendulum axis 27, the position of which in three dimensions is determined by the particular position of control arms 14, 15. This to-and-fro motion of rear axle 7 about virtual pendulum axis 27 simultaneously results in a displacement 28 of rear axle 7 transversely to direction of travel FR. Displacement 28 of rear axle 7 results in an increase in the distance 29 between wheel 6a located in the displacement direction and adjacent region 8a of chassis 10, while further wheel 6b is swiveled underneath region 8b of chassis 9 adjacent to wheel 6b, thereby considerably reducing the risk of collision between steered wheels 6a, b of rear axle 7 and chassis 9 when agricultural working machine 1 is driven on a slope. A particularly secure and force-appropriate pendulum motion of rear axle 7 is attained when control arms 14, 15 are both the same size, that is, upper and lower joints 16-19 are separated by the same distance 30 for each control arm 14, 15, and when distance 30 is greater than distance 20 between upper joints 16, 17 of adjacent control arms 14, 15.

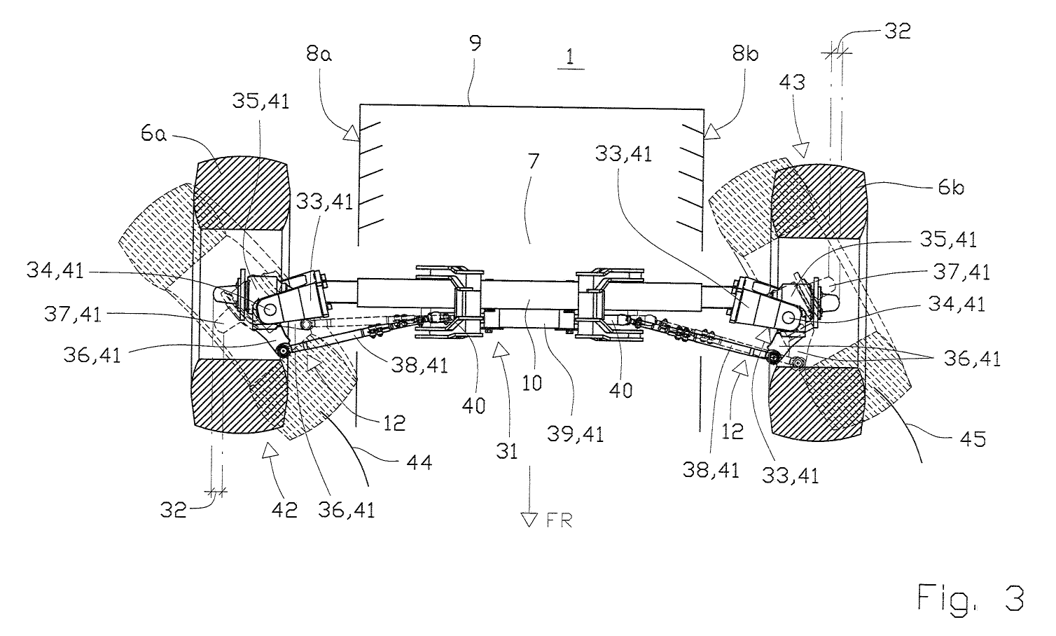

FIG. 3 shows, in detail, swivel device 12, according to the invention, which pivotably connects respective wheel 6a, 6b assigned to it to axle body 10 of rear axle 7. Swivel device 12 is designed as coupler mechanism 31, wherein the actuation, to be described in greater detail, of coupler mechanism 31 results in a displacement 32, transversely to direction of travel FR, of wheels 6a, 6b of rear axle 7 relative to axle body 10.

In the embodiment shown, swivel device 12 includes forked swivel supports 33 that are rotatably connected to axle body 10 and are used to pivotably accommodate king pins 34 assigned to each wheel 6a, 6b. Each king pin 34 is enclosed, in a freely rotatable manner, by respective spindle 35 and a track rod fastening part 36 integrally formed thereon at an angle, wherein spindle 35, at its free end, transitions into stub axle hub 37 which ultimately accommodates respective wheel 6a, 6b of rear axle 7. According to the invention, each king pin 34 is located ahead—relative to direction of forward travel FR of agricultural working machine 1—of spindle 35 assigned to it. Furthermore, track rod fastening parts 36 each hingedly accommodate a track rod 38 on their free ends. On the other ends, each track rod 38 is pivotably connected to steering cylinder 39 which is designed as a double-acting lifting cylinder, wherein steering cylinder 39 is fixed in position on axle body 10 of rear axle 7. By applying pressure to steering cylinder 39, piston rods 40 are extended away from steering cylinder 39 or are retracted into it, wherein wheels 6a, 6b of rear axle 7 can move between steering positions shown in FIG. 3 as solid and dashed lines. In the embodiment shown, swivel supports 33, king pins 34, spindles 35 with associated spindle hub 37, track rod fastening parts 36, track rod 38 and steering cylinder 39 therefore form coupling elements 41 of swivel device 12 according to the invention.

In addition, the lengths of coupling elements 41 are matched to each other such that wheels 6a, 6b of rear axle 7 assume a position in the maximum curve position, which is depicted in FIG. 3, in which inner wheel 6a has a front edge 42 that is located in the vicinity of region 8 of chassis 9 adjacent to wheel 6a, and in which a rear edge 43 of outer wheel 6b is located in the vicinity of region 8 of chassis 9 adjacent to wheel 6b. The dimensions of coupling elements 41 are selected such that, in the maximum curve position depicted in FIG. 3, inner wheel 6a has a turning radius 44 that is smaller than turning radius 45 of outer wheel 6b, that is, steerable wheels 6a, 6b of rear axle 7 have moved through different steering angles until they reached their maximum steering positions, thereby ensuring that a collision with regions 8 of chassis 9 is prevented even in maximum steering positions.

It will be understood that each of the elements described above, or two or more together, may also find a useful application in other types of constructions differing from the types described above.

While the invention has been illustrated and described as embodied in a vehicle having an axle capable of pendulum motion, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A vehicle, comprising a chassis, at least one front axle assigned to said chassis and carrying land wheels, a rear axle located downstream of said front axle, relative to a direction of forward travel and carrying at least two steerable wheels, wherein said rear axle is hingedly connected to said chassis such that it is movable to and fro transversely to the direction of travel, and includes at least one axle body, wherein regions of said chassis are assigned to said wheels of said rear axle in an at partially adjacent manner, a pendulum device coupling said rear axle of said chassis and enabling a displacement of said rear axle that is oriented transversely to the direction of travel, and a swivel device coupling each wheel of said rear axle to said axle body of said rear axle and enabling a displacement of each wheel that is oriented transversely to the direction of travel.

2. The vehicle as defined in claim 1, wherein said pendulum device is a coupler mechanism having coupling elements which perform a slope-induced movement and thereby cause the displacement of said rear axle transversely to the direction of travel.

3. The vehicle as defined in claim 2, wherein said rear axle is displaceable so that a displacement of said rear axle results in an increase of a distance of one of the wheels located in a displacement direction from one region of said chassis adjacent to it, while a further one of the wheels is swiveled underneath another region of said chassis that is adjacent to said further wheel.

4. The vehicle as defined in claim 1, wherein said coupling elements are control arms situated in pairs, each connected to said axle body and said chassis by upper and lower joints, such that a distance between said upper joints is smaller than a distance between said lower joints.

5. The vehicle as defined in claim 4, wherein said upper and lower joints of each of said control arms situated in pairs are separated by a same distance, and said same distance is smaller than a distance between said lower joints.

6. The vehicle as defined in claim 1, wherein said swivel device is a coupler mechanism having coupling elements such that a motion of said coupling elements induces the displacement oriented transversely to the direction of travel of said wheels of said rear axle relative to said body.

7. The vehicle as defined in claim 6, wherein said coupler mechanism of said swivel device, in addition to said coupling elements, includes swivel supports assigned to each of said wheels and mounted on said rear axle, a king pin accommodated by said swivel supports in a pivoting manner, a spindle transitioning into a spindle hub and rotatably connected to said king pin, wherein said spindle hub accommodates a respective one of said wheels, and said king pin is located ahead of a respective spindle relative to the direction of forward travel.

8. The vehicle as defined in claim 7, where each said coupler mechanism of said swivel device includes a track rod fastening part assigned to said swivel support and pivotably accommodating a track rod.

9. The vehicle as defined in claim 8, further comprising a steering cylinder which is a double-acting lifting cylinder assigned to said rear axle, fixed in position on said axle body of said rear axle, and pivotably coupled to each of the track rods.

10. The vehicle as defined in claim 1, wherein said wheels of said rear axle assume a position in a maximum curve position in which an inner wheel of said wheels has a front edge located in a vicinity of a region of said chassis adjacent to said inner wheel, and in which a rear edge of an outer wheel of said wheels is located in a vicinity of a region of said chassis adjacent to said outer wheel.

11. The vehicle as defined in claim 10, wherein in said maximum curve position said inner wheel has a turning radius that is smaller than a turning radius of said outer wheel.

12. The vehicle as defined in claim 1, wherein said vehicle is an agricultural working machine.

13. The vehicle as defined in claim 1, wherein said vehicle is a combine harvester.
